(19) United States
(12) Patent Application Publication
(10) Pub. No.: US 2004/0093780 A1
(43) Pub. Date: May 20, 2004

(54) Three-dimensional indication with sign-figures

(76) Inventor: Nikolay Pavlov Atanasov, Sofia (BG)

Correspondence Address: Richard L Byrne, 700 Koppers Building, 436 Seventh Avenue, Pittburgh, PA, 15219-1818, US

(21) Appl. No.: 10/276,184

(22) PCT Filed: Mar. 14, 2001
(86) PCT No.: PCT/BG01/00007

(30) Foreign Application Priority Data
May 19, 2000 (BG) 104462

(51) Int. Cl. G09F 7/00

(52) U.S. Cl. 40/596

(57) ABSTRACT

The invention applies about the method and sign figures, which find application for three-D indication. It can to use in multifarious plays and for display of information with indicative, demonstrative, advertising and other type of character. The Method and sign figures for three-D indication increase on possibilities of indication and to utilize fully distinguishing function of the three-D in the space. Every sign figure involves some alike on the form sign frame, which make letters, numerals, drawings and combinations from them or others components of figures. With the purpose to increase on possibilities of indication and to utilize fully distinguishing function on three-D in the space the sign figures is trilateral or multilateral synonymous. The sign figure involves three or more sign frames, which compose one structure and are connect sedentary in one or some points in common, and sides or from part from the format by it. On size sign frames are equal or deferent. The sizes of deferent sign frames increase on progression. The sign figures have radial-symmetrically position, is pyramidal position and three co-ordinate positions. In sign figures with radial-symmetrically position, the sign frames compose pyramidal surface. In sign figures with three co-ordinate position, the sign frames are disposed in three basically directions on the space, and one from the sign frames serves for the base. The Priority of invention consists in the next: add difference of the sign simultaneously in the all dimensions of the space. It grows strong the effect as stand complete visibility of the format of the sign, and it is especially when moving and veering of the individual. It has accessibility and comfort in the application of the sign figure.

### FIELD OF THE INVENTION

The present invention relates to sign figures for three-dimensional indication, which use for three-dimensional indication of different elements in games, for example three-D crossword-puzzle and others plays for display on information with indicative, demonstrative, advertising and other type of nature on roads, crossing, islands and etc.

### BACKGROUND OF THE INVENTION

Known is different by character and purpose sign figures, which are replete with sign bodies, and represent letters, digits or others figures.

Noted is a block of letters demonstration (U.S. Pat. No. 3,822,487), which includes a plurality of different letters, which are connected sedentary, each other so as to form three-dimensional block form. As sign bodies put upon letters which can be connected in horizontal or vertical level and to be situated each round other.

Deficiency of known three-dimensional block of letters is that the way of connecting and emplacement of constructing letters allows indication according utilizing in meaning of communication only in two space. Formed by this way three-dimensional figure has not enable to utilize fully distinguishing function of three dimensions, which in significant degree restricts applied field of invention. Other defect of known sign figure is connected with the necessary from imposing of additional set-ups, appliances, panels, and others for emplacement of sign figures, and in the result of which there is limited visual adoption from the some side of indication and identification of the sign of the sign. This negative effect would be evince in many bigger degree about utilizing of sign figures for resigning of information, advertising on streets, roads especially if the face side of sign figures is not perpendicular located on direction of move. Of this case consumers are in movement and have possibility to perceive full bodily the sign figures only when they are in the definite position. Of these cause the attention of individuals and machine-minders turns aside and keeps long time till crossing the said convenient position, out of which reduces in significant degree the security of motion.

Further is a necessity and from extra devices, adjustments, indicator panels and others for disposal of sign figures as holds back some-one from the directions of indication and identification of the sign. That is especially complicates reliance on information when moving of the individual as it protractedly holds the attention of individual and turn aside and reduce safety of motion, and it is especially if face frequent of sign figure is not perpendicular located on direction of motion.

Known is the game for education (U.S. Pat. No. 4,430,825) which is related to three dimensional figure, and which is formed from different digital signs which are situated and connected among so as to resemble human face. The last is formed only from making of sign figures—digital with different extents which situated on fixed place has function of part of human head—cranium—0, eyes—8, hears—6, nose—4 and others.

Defect of the description known three dimensional sign figure is its limited application as using only of digital signs and with purpose creating of fantastic forms of human head with different expression. The composed volumetric form has three-D character but the separated sign figures are really filling and situated so that they are perceived only in two-D space. The sign frame in the sign figure is not serve to identifying the sign facing simultaneously in the three dimensional space. The facing form of the sign and massiveness of the sign body is requisition to designation and showing importance and meaning of some other object or the part of something, but no of sign by itself For example, in the game for education (U.S. Pat. No. 4,430,825) the sign 0—cranium, 8—eyes, 6—hears, 4—nose and others. In this case lack suitable rank of joining of the sign and structure for identifying and as second and third dimension of the identical sign simultaneously from tree dimensional directions of the space of everyone sign frame in the plurality of related signs.

Known is puzzle game (P No 2219216—UK), which is related next three-dimensional figure, and which is constructed from a plurality of elements with surface and different configuration what can be letters, digits, geometric forms and others.

Defect of known three-D figure is that the plurality of elements is not connected by manner which to show the sign form equally in three dimensions of the space, and shows only the sign facing in one direction or two directions of the space. And at this innovation the sign body in the sign figures serves for designation and construction on something otherwise, but no for indication of itself simultaneously in the three directions of the space.

### OBJECT OF THE INVENTION

The purpose of the invention is to create a sign figure for three-dimensional indication of uniform sign frame and as second and third dimension of the identical sign, which to allow full value using of three-D indication facing frame. And the sign figure to be expressed in clear and comfortable visual perceiving of comprising information through the sign figure, and to be differentiated with easily realization of different constructions from signs with aim extending of their appliance.

The task of invention is decided with sign figure, which includes more from one sign frame, and which sign frames are connected sedentary among themselves.

According to the invention the sign figure represents one sign and as second and third dimension of the identical sign simultaneously in the three dimensions of the space. And it is a complex from other figurative elements or combination of them.

According to one realization of the invention the sign figure consists sign frames with uniformly facing form, which represents one sign and as second and third dimension of the identical sign simultaneously in the three dimensions of the space. And it consists at least from three equals by form signs frames, which are connected among themselves at least one join point, side or a part. The sign frames can be making as letters, numerals, drawings and combinations of them, and they can be making from equal by sizes sign frames or sign frames with sizes, which increase on progression.

According to one preferred realization of the innovation the sign figure is implemented from sign frames, which have a radial-symmetrically position as the sign frames are situated in the vertical oriented plain.

According to other preferred realization of the innovation the sign figure is implemented from sign frames with pyramidal position, as the sign frames make a pyramidal surface.

The innovation can be implemented and from sign frames which are situated in three co-ordinate position as one of the sign frames uses as a base.

It is possible a making of sign figure according to the invention, which represents a combination of some sign figures with a radial-symmetrically position of sign, frames and a pyramidal position of sign frames.

It is possible and one other making of sign figure, which represents a combination from a radial-symmetrically position and three co-ordinate positions of the sign frames.

Other making of the sign figure is differentiated with this that it is implementing as combination from a pyramidal position and three co-ordinate positions of the sign frames.

The sign figures in according to the invention are differentiated with functionality at using of so described complex from sign figures, which is expressed in the increase possibility for visual distinguishing of the sign frame simultaneously in the three-D of the space. There is keeping full visibility of the sign form specially in the moving and the change of position of the consumers. By this way it get an additional increasing of a visual effect of sign figure at clear expressive approach and facility at the using of sign figures.

### SUMMARY OF THE INVENTION

The priority of invention consists in the next: add difference of the sign simultaneously in the all dimensions of the space. It grows strong the effect as stand complete visibility of the format of the sign, and it is especially when moving and veering of the individual. It has accessibility and comfort in the application of the sign figure.

### BRIEF DESCRIPTION OF THE DRAWINGS

Farther in the description are uncovered more in and out pattern interpretations of the signs figures for three indication with the help of figures which accompany the description and where:

FIG. 1 is a general type of sign figure with radial-symmetrically position.

FIG. 2 is a general type of sign figure with radial-symmetrically position and with deferent on sizes, but equal on form of frame.

FIG. 3 is a general type of the sign figure with pyramidal position.

FIG. 4 is a general type of the sign figure with three co-ordinate positions.

### EXAMPLES FOR IMPLEMENTING OF THE INNOVATION

Farther in the description are represented patterns for implementation of the innovation, which don't restrict constructing of other signs figures, which are implemented by conditions of described basically elements and connections among them.

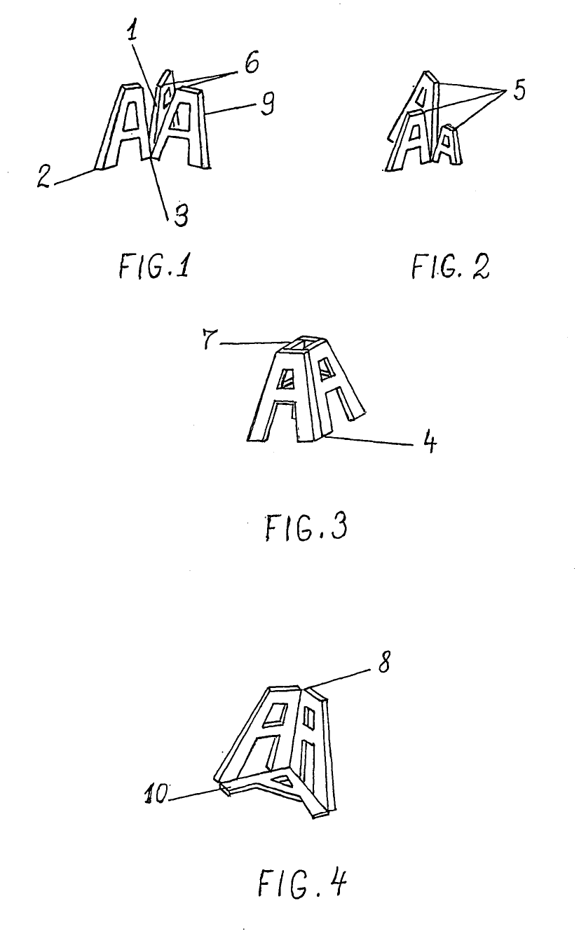

Every sign figure for tree-dimensional indication involves sign FIG. 1 making as a complex from sign frames 2 with a face by kind of one sign and as second and third dimension of the identical sign simultaneously in the three dimension of the space. The sign FIG. 1 are trilateral or multilateral synonymous definite as the sign frames 2 are equal by form of sign face and at least three by number. The sign frames 2 compose one three structure and are connected sedentary at least in one join point 3, and sides 4 or with separated parts from the sides or their form. The sign frames 2, from which are constructed three-dimensional figure, can to be implementation with equal and different size or with sizes 5, which increase on progression. The sign frames 2 can to be situated so that to compose different by configuration sign figures, for example: radial-symmetrically position 6 (FIG. 2), pyramidal position 7 (FIG. 3) and three co-ordinate positions 8 (FIG. 4). In sign FIG. 1 with a radial-symmetrically position 6, the sign frames 2 with equal by form sign face are with a vertical position 9, such as they are connected in one join point 3. In sign FIG. 1 with a pyramidal position 7 the sign frames 2 with equal by form sign face compose the pyramidal surface such as are connected at the line of four join sides. About the implementation of the sign FIG. 1 with a three co-ordinate position 8 the sign frames 2 with equal by form sign face are disposed in the three basically directions of the space, such as one from the sign frames 2 serves for a base 10. And it is connected with others sign frames by join part from their sides.

The sign figures can have a different applied field by which utilize as put in order and dependency from the type of the sign, which carry, and from the meaning and matter of the message, which sign figures model. For example it is possible to be implement figures by which can put on horizontal, vertical and in depth, such as saves the possibility to be differentiate from everyone direction in the space. For indication can use sign figures from one or some types of the described spatial implementations, which pivot on a deferent position of sign frames in them.

### Prior art

1. U.S. Pat. No. 3,822,487, 1974.

2. U.S. Pat. No. 4,430,825, 1984.

3. P 2219216—UK, 1989.

1. A sign figure for three-dimensional indication involves sedentary connected among themselves sign frames (2) with different sizes, characterized in that it represents the face of one sign and as second and third dimension of the identical sign simultaneously in the three dimensions of the space, and it is a complex from at least three and equal by form sign frames (2); which are connected among themselves at least in one join point (3), and side (4) or a part of their form, such as the sign frames (2) can be implement as letters, digits, drawings and other figurative elements or combination of them.

2. A sign figure for three-dimensional indication, according to claim 1, characterized in that said sign figure (1) can be implement from equal by size sign frames (2) or sign frames (2) with sizes which increase on progression (5) and with equal by form sign face.

3. A sign figure for three-dimensional indication, according to claim 1, characterized in that said sign figure (1) is implemented from sign frames (2) with equal by form sign face, which have radial-symmetrically position (6) as the sign frames (2) are situated in the vertical oriented level.

4. A sign figure for three-dimensional indication, according to claim 1, characterized in that said sign figure is implemented from sign frames (2) with pyramidal position (7) by which compose the pyramidal surface, which are equal by form sign face.

5. A sign figure for three-dimensional indication, according to claim 1, characterized in that said sign frames (2) are with equal by form sign face and are situated in three co-ordinate positions (8), as one from the sign frames (2) utilizes as base (10) of the sign figure.

6. A sign figure for three-dimensional indication, according to claim 1, characterized in that it is implemented as combination from sign figure (1) with radial-symmetrically position (6) of the sign frames (2) with equal by form sign face and sign figure (1) with pyramidal position (7) of the sign frames (2) with equal by form sign face, and which sign figures (1) put on horizontal, vertical and in depth.

7. A sign figure for three-dimensional indication, according to claim 1, characterized in that it represents combination from sign figures (1) with radial symmetrically position (6) of the sign frames (2) with equal by form sign face and sign figures (1) with three co-ordinate positions (8) of the sign frames (2) with equal by form sign face, and which sign figures (1) put on horizontal, vertical and in depth.

8. A sign figure for three dimensional indication, according to claim 1, characterized in that it is implemented as combination from sign figure (1) with pyramidal position (7) of the sign frames (2) with equal by form sign face and sign figure (1) with three co-ordinate positions (8) of the sign frames (2) with equal by form sign face, and which sign figures (1) put on horizontal, vertical and in depth.
